(19) United States
(12) Patent Application Publication
(10) Pub. No.: US 2017/0015532 A1
(43) Pub. Date: Jan. 19, 2017

(54) MOVING CRANE

(71) Applicant: KONECRANES GLOBAL CORPORATION, Hyvinkää (FI)

(72) Inventors: Esa OJAPALO, Riihimäki (FI); Juha SANTALA, Kerava (FI); Hannu OJA, Hyvinkää (FI)

(73) Assignee: Konecranes Global Corporation, Hyvinkää (FI)

(21) Appl. No.: 15/301,222

(22) PCT Filed: Apr. 2, 2015
(86) PCT No.: PCT/FI2015/050234

§ 371 Date: Sep. 30, 2016

(30) Foreign Application Priority Data
Apr. 4, 2014 (FI) U20144081

(51) Int. Cl. B66C 19/00; B66C 13/18; B66C 13/16; B66C 13/54

(52) U.S. Cl. CPC B66C 19/007; B66C 13/54; B66C 13/18; B66C 13/16

(57) ABSTRACT

A moving crane including a frame which, in its upper part, is provided with a main support structure and which, in its lower part and on opposite sides of the lower part of the frame, is provided with lower beam structures transverse to the main support structure; at least one wheel or wheel arrangement at both ends of the lower beam structures, i.e. in each lower corner of the crane; a trolley arranged to move along the main support structure and provided with a hoisting member; a hoisting mechanism for driving the hoisting member of the trolley, and a cab for the crane operator, whereby the cab is placed in connection with one lower beam structure and the hoisting mechanism in connection with the other lower beam structure.

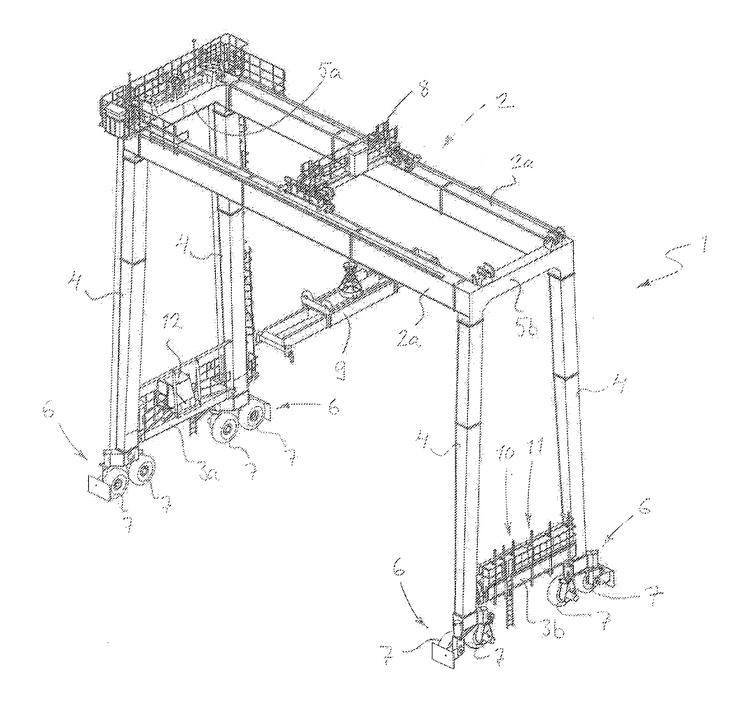

### FIELD OF THE INVENTION

The invention relates to a moving crane comprising a frame which, in its upper part, is provided with a main support structure and which, in its lower part and on opposite sides of the lower part of the frame, is provided with lower beam structures transverse to the main support structure; at least one wheel or wheel arrangement at both ends of the lower beam structures, i.e. in each lower corner of the crane; a trolley arranged to move along the main support structure and provided with a hoisting member; a hoisting mechanism for driving the hoisting member of the trolley; and a cab for the crane operator.

Such yard gantry cranes for storage areas in container terminals are designed for arranging and handling containers in a container storage yard. They move along paths parallel with container rows, either on rails or rubber wheels.

Typically, the cab and hoisting mechanism of such a crane are located in a trolley moving on top of the main support structure of the crane, in which case the masses to be moved are quite large, which has a substantial influence on the dimensioning of the support structures of the entire crane.

The crane operator's work place is in a trolley moving high up, which requires a large number of passages and stairs on the foot and upper structures of the crane, when taking into account the need to get out of the crane in potential fault and danger situations when the trolley is in the middle of the span of a crane, or at one end of it. A crane operator sees a loading member from the cab at an angle from above, and any steering movements and actions on the loading area, in particular those close to the ground level, may be imprecise. Bad weather and lighting conditions further have an impairing effect on them.

The prior art solution also requires demanding service and maintenance procedures to be taken into consideration in places that are high up where the necessary, possibly heavy and large spare parts also have to be taken in connection with service operations.

### SUMMARY OF THE INVENTION

An object of the invention is to provide a crane so as to enable the above-described problems to be solved. This object is achieved by means of the crane according to the invention, which is characterised in that the cab is placed in connection with one lower beam structure and the hoisting mechanism in connection with the other lower beam structure. Preferred embodiments of the invention are disclosed in the dependent claims.

When the cab is located close to the ground level, right in front of the loading area, in the lower part of the leg structure at one end of the crane, in other words in connection with the aforementioned lower beam structure, it is possible to control the loading and unloading operations of trucks and carriages requiring special accuracy from a short distance and from the best possible monitoring spot providing a crane operator with the shortest seeing distance to the loading area. This enables the operation to be made as safe as possible. An additional advantage herein is that the crane operator does not have to climb all the way to the main support level since the working height is at a substantially lower level than in a conventional yard gantry crane.

To provide a more detailed description, when the cab is at a low level, the following benefits are obtained:
An operator's ergonomics in a continuous working position is notably better when the operator may sit upright in his chair. A standing position is also possible. Earlier, the working position in a cab placed high up was awkward and strained the support and movement organs: an operator is continuously sitting in a forward stooped position and looking straight down between his spread out legs.
Easier loading and unloading on truck lanes, the operator sees the lowering/hoisting operation from the side and from the right height as a container goes down on or up from a trailer. In prior art, the operator sees the lowering/hoisting situation from high above whereby it is difficult to detect a depth difference of 0-0.5 m between a container and the upper surface of a trailer. The hoisting capacity of a crane is so big that it is difficult to notice any essential change in the hoisting power when hoisting an empty or partially filled container, as seen from above, if the container is not fully disconnected from the corner locks that keep the container in place, in other words, it is possible to lift a truck's trailer by accident. Such an inadvertent situation may be easily avoided when a crane operator has a field of view from the side to a container being handled.
When a container is being lowered on/hoisted from a trailer, the truck driver is, as agreed on, in his own cabin and is not allowed to come out in the loading area. When the crane operator is in practise at the same level as the truck driver, the opportunity exists for mutual dialogue between them, and at the final stage of the lowering/early stage of the hoisting, safety may be increased as the container is loaded/unloaded at the back side of the truck driver's cabin.
A possible operator's fit during a work shift is more easily sorted out, because the operator need not be removed from a cab placed high up. In some cases, the removal of a person who has had a fit from an overhead cab needs to be organised by a mobile crane or a helicopter. Furthermore, it is easier to arrange operator changes as work shifts change and training situations of various kind when the cab is at a low level. This is naturally possible since the ladder runs to be arranged are shorter and located lower.
The cab may also be built in a light-weight manner whenever there is the option to build separate stiffening steel structures outside of it, in case a container should become loose during a hoist, to prevent the operator from getting squeezed. Stiffening steel structures, that is, safety structures, are more economical to construct than to make the cab stiff, in particular as regards a load falling on it. The stiffeners may be placed in front of and/or obliquely above the cab.

Similarly, when the hoisting mechanism is also located close to the ground level in connection with the other lower beam structure, it is possible to place them close to the main power source, making electrisation simpler and improving the weight distribution of the crane. Items in need of servicing are more easily available and the necessary spare parts can be easily brought thereto by means of a fork-lift truck, for instance. When the control cabin thus at the same time remains in connection with the lower beam structure located on a side opposite to the crane, the control cabin is situated far away from the sources of noise and vibration. Further, an optimum protection of the cab and operator from exhaust noise is achieved as exhaust fumes are directed substantially straight up, whereby the exhaust port of the exhaust pipe may be placed as far away from the operator as possible. While handling a load, when the container is lowered or lifted substantially at the level of the cab, the container itself forms a temporary noise wall between the machine unit and the cab.

When the machinery and the cab are moved from the trolley to be located close to the ground level, the trolley becomes light in structure, enabling also the support structure of the crane to be made lighter. At the same time, of course, the centre of gravity of the crane becomes to be situated lower, stabilizing the travel of the crane. Also, fewer passageways and platforms are required in the upper part when no emergency exits are necessary from top to bottom in case of fires or other accidents.

The parts of the crane are designed such that they can be packed and transported as modules in containers to the installation site. This makes the transportation easier to plan, when no large structural steel parts and components have to be transported separately as general cargo. The main support structure and the legs are built from interconnectable beam parts to be interconnected at the installation site. The rest of the parts are designed in a similar manner so as to be packed in containers. Packing in containers provides advantages in logistics whereby energy will be saved when examining the issue as a whole. The effects caused by the weather are diminished, and transporting as well as packing are simplified.

From the point of view of the total energy usage of a yard gantry crane, the carbon footprint is lower than with prior art solutions as the design of the machinery, cabling, and energy usage are reduced by counterweights, in addition to the aforementioned logistics advantages. The amount of energy used for manufacturing is smaller and the assembly of the device from modules at the delivery site is simple.

### LIST OF FIGURES

The invention will now be described in closer detail with reference to the accompanying perspective drawing of a crane according to the invention.

### DETAILED DESCRIPTION OF THE INVENTION

Referring to the FIGURE, a moving crane according to the invention has a frame 1 which, in its upper part, is provided with a main support structure 2 and which, in its lower part and on opposite sides of the lower part of the frame 1, is provided with lower beam structures 3a and 3b transverse to the main support structure 2. The main support structure 2 is connected to the lower beam structures 3a and 3b by upright legs 4. The main support structure 2 herein comprises two main supports 2a travelling, spaced apart from one another, parallelly and connected to one another by upper beam structures 5a and 5b.

The ends of the lower beam structures 3a and 3b are provided with bogie structures 6, each comprising two successive wheels 7. The total number of bogie structures 6 is thus four, one in each lower corner of the crane. In this example, the wheels are rubber wheels and, typically, one of the wheels 7 of each bogie 6 is a drive wheel while the other is a driven wheel. In connection with a rubber wheel crane, the wheels 6 are preferably also turnable. Alternatively, the number of wheels 7 could be four in each bogie structure 6 (two pairs of wheels in succession), or only one wheel 7 could be provided in each lower corner (in which case the structure is not a bogie structure). As already stated above, the wheels of the crane could also be (non-turning) wheels travelling on rails.

Along the main support structure 2, a trolley 8 is arranged to move, a hoisting member (loading member) 9 of the crane hanging therefrom.

In addition, the crane comprises a hoisting mechanism 10 for driving the hoisting member 9 of the trolley, a main power source 11 of the crane, and a cab 12 for the crane operator. The hoisting member 9 is connected to the hoisting mechanism 10 by ropes (not shown) or similar. In accordance with the invention, the cab 12 is located in connection with one lower beam structure 3a while the hoisting mechanism 10 is located in connection with the other lower beam structure 3b; to be more precise, in this example the cab 12 is located on top of the lower beam structure 3a and the hoisting mechanism 10 on top of the lower beam structure 3b. The cab 12 is located in the middle of the lower beam structure 3a. The main power source 11, in turn, is located in connection with the same lower beam structure 3b as the hoisting mechanism 10. Preferably, the cab 12, the hoisting mechanism 10, and the main power source 11 are modular structures to be installed in the crane. This structural entity according to the invention enables the advantages described in detail above to be achieved.

The cab 12 may additionally be equipped with a detachable local controller (not shown), whereby an operator is able to move to a suitable spot outside of the cab 12 and to control the use of the crane from the best possible monitoring position.

It is preferable to provide the trolley 8 and its hoisting member 9 with cameras (not shown) to enable the container handling procedures in the storage area to be carried out sufficiently accurately, as the crane operator no longer monitors the storage sites obliquely downward.

It is also beneficial that working lamps are installed on the main supports 2a, powerful enough so that when they are mainly or fully directed downward, the light provided by them on the container yard is spread so widely in the sideward direction that no horizontal headlamps will, in practise, be needed. There may be, for example, five lamps in a row below each main support 2a.

A cab 12 placed low refers to a cab 12 placed at such a height that it is placed at substantially the same level as the height of loading a platform of a semitrailer of a truck. The height of the cab 12 from the ground, that is, the bottom of wheels 7, may also be defined as a ratio in proportion to the size of the wheels 7. In an eight-wheel crane, the operator's seat level in the cab is placed at a height of approximately 4.0 metres from the ground level, so therefore the operator's eyes are at a height of approximately 4.7 metres. When the typical wheel diameter is approximately 1.68 metres, the height of the operator's seat level from the ground is approximately 2.4 times the wheel diameter. Similarly, a sixteen-wheel one uses a slightly smaller wheel diameter, typically 1.37 metres, so in this case the height of 4.0 metres that the operator's seat level is from the ground is approximately 2.9 times the wheel diameter. The specific purpose of height placement is to provide the crane operator with a view to the top level of a container placed on the trailer of a truck. In such a case, the crane operator also has a good top view to the trailer of a truck as seen slightly from above. The position of the cab and the operator is arranged so that the operator's eyes are advantageously at the top edge level of a container placed on the trailer of a truck, or slightly above it. A cab 12 placed low also has an open view obliquely upward whereby a lifted container being handled is seen from an oblique downward angle.

By using a detachable local controller, an operator also has the chance to control the crane from the outside of the cab or driving compartment. The move of the controlling option may also be enabled by transferring the SIM card, only, from the controller of the cab 12 to another controller which is suitable for use in the yard for handling a load, for example, or for the servicing time of the crane. The transfer of the SIM card also ensures that the control option is only active on the controller brought to the yard, and the controller 12 left in the cab is passive whereby a simultaneous use of two controllers cannot cause an accident. Remote controllers of other types are possible, too.

Typically, such a crane is large, in which case the main support structure 2 extends over a plurality of lines of containers. In order to be able to further move the centre of gravity of the crane lower, it is preferable to make the main supports 2a reside close to one another, in which case the upper beam structures 5a and 5b become shorter and, thus, lighter. Thus, the upright legs 4 then obliquely join the lower beam structures 3a and 3b, when viewing the crane from its side. This, of course, at the same time saves material, stabilizes the entire crane and makes the structure stiffer.

The above description of the invention is only intended to illustrate the basic idea of the invention. A person skilled in the art may thus vary its details within the scope of the attached claims. It is to be noted that the main power source may alternatively also comprise a cable drum and a guide bar, in which case the appearance of the crane differs from the structure being shown in the drawing. In such a case, the crane depends on an external energy source, and it is supplied by an electric cable following the surface of the ground and being uncoiled by the crane onto the large cable drum. This embodiment may be relevant in connection with a crane travelling on rails.

1-11. (canceled)

12. A moving crane comprising:
a frame, an upper part of the frame being provided with a main support structure, a lower part of the frame, and on opposite sides of the lower part of the frame, being provided with lower beam structures transverse to the main support structure;
at least one wheel or wheel arrangement at both ends of the lower beam structures;
a trolley arranged to move along the main support structure and provided with a hoisting member;
a hoisting mechanism for driving the hoisting member of the trolley; and
a cab for a crane operator,
wherein the cab is placed in connection with one lower beam structure and the hoisting mechanism in connection with the other lower beam structure, and wherein a view to the top level of a container placed on the trailer of a truck is provided for the crane operator.

13. The crane as claimed in claim 12, wherein the cab is placed on top of one lower beam structure and the hoisting mechanism on top of the other lower beam structure.

14. The crane as claimed in claim 12, wherein the cab is placed in the middle of the lower beam structure.

15. The crane as claimed in claim 12, wherein the crane comprises a main power source placed therein in connection with the same lower beam structure as the hoisting mechanism.

16. The crane as claimed in claim 12, wherein the cab, the hoisting mechanism, a main power source and the wheel arrangement are modular structures to be installed in the crane.

17. The crane as claimed in claim 12, wherein the cab is provided with a detachable local controller.

18. The crane as claimed in claim 12, wherein the crane is provided with a remote controller.

19. The crane as claimed in claim 12, wherein the trolley and the hoisting member are provided with cameras.

20. The crane as claimed in claim 12, wherein an eight-wheel crane has the seat level of the cab, as measured from ground level, at a height corresponding to 1.5-3.5 times the diameter of the wheel.

21. The crane as claimed in claim 12, wherein a sixteen-wheel crane has the seat level of the cab, as measured from ground level, at a height corresponding to 2-4 times the diameter of the wheel.

22. The crane as claimed in claim 12, wherein the seat level of the cab is located at a height of 3.3.-5.0 metres from ground level.
